(19) United States
(12) Patent Application Publication
(10) Pub. No.: US 2026/0160219 A1
(43) Pub. Date: Jun. 11, 2026

(54) CYLINDER, INTERNAL COMBUSTION ENGINE, AND VEHICLE

(71) Applicant: Isuzu Motors Limited, Yokohama-shi (JP)

(72) Inventor: Kazaki KURATSUJI, Fujisawa-shi (JP)

(73) Assignee: Isuzu Motors Limited, Yokohama-shi (JP)

(21) Appl. No.: 19/403,316

(22) Filed: Nov. 28, 2025

(30) Foreign Application Priority Data
Dec. 9, 2024 (JP) 2024-214356

(51) Int. Cl. F02F 1/18

(52) U.S. Cl. CPC F02F 1/18

(57) ABSTRACT

A cylinder includes: an inner wall surface in which a plurality of types of recesses are formed in positions offset for each type in a moving direction of a piston. For the plurality of types of recesses, an influence on a relationship between a moving speed of the piston and friction between the inner wall surface and the piston is different for each type. Recess rows are formed in a position offset in the moving direction with respect to the other recess rows. In each of the recess rows, recesses of one type are arranged in a circumferential direction. In recess rows adjacent to each other in the moving direction, recesses of an upper-side recess row and recesses of a lower-side recess row are alternately arranged along the circumferential direction, and a bottom end of the upper-side recess row are located below a top end of the lower-side recess row.

### CROSS-REFERENCE TO RELATED APPLICATIONS

This application is based upon and claims the benefit of priority from Japanese Patent Application No. 2024-214356, filed Dec. 9, 2024, the entire contents of which are incorporated herein by reference.

### FIELD

The present disclosure relates to a cylinder, an internal combustion engine, and a vehicle.

### BACKGROUND

Conventionally, it is known that friction between a piston that moves with respect to an inner wall surface of a cylinder provided in an internal combustion engine and the inner wall surface changes when a plurality of recesses are formed in the inner wall surface from a state in which the plurality of recesses are not formed in the inner wall surface(for example, Jpn. Pat. Appln. KOKAI Publication No. 2007-46660). Once the plurality of recesses are formed in the inner wall surface, an amount of friction reduction increases at a portion of the inner wall surface that faces the piston when the piston moves at a high speed with respect to the inner wall surface (hereinafter referred to as a high-speed region). The friction reduction amount varies depending on types of recesses such as a depth and shape of the recesses. When recesses of a specified type are formed, the friction reduction amount in the high-speed region becomes larger than when recesses of the other types are formed in the inner wall surface. Thus, there are recesses of types that are advantageous in high-speed regions.

### SUMMARY

A cylinder includes: an inner wall surface in which a plurality of types of recesses are formed in positions offset for each type in a moving direction of a piston. For the plurality of types of recesses, an influence on a relationship between a moving speed of the piston and friction between the inner wall surface and the piston is different for each type. In the inner wall surface, at least one of a plurality of recess rows are formed by the plurality of types of recesses in a position offset in the moving direction with respect to the other recess rows. In each of the plurality of recess rows, two or more recesses of one type are arranged in a circumferential direction. In recess rows adjacent to each other in the moving direction, two or more recesses of an upper-side recess row and two or more recesses of a lower-side recess row are alternately arranged along the circumferential direction, and a bottom end of the upper-side recess row are located below a top end of the lower-side recess row.

### BRIEF DESCRIPTION OF THE DRAWINGS

FIG. 1 is a schematic diagram illustrating an example of a structure of a vehicle according to an embodiment.

FIG. 2 is a schematic diagram illustrating an example of a structure of an internal combustion engine according to the embodiment.

FIG. 3 is a cross-sectional view schematically illustrating, by a cross section, an example of a structure of an outer peripheral surface and the vicinity thereof of a piston according to the embodiment.

FIG. 4 is a schematic diagram illustrating a structure of an inner wall surface of a cylinder according to the embodiment.

FIG. 5 is a diagram for describing a plurality of recesses according to the embodiment.

FIG. 6 is a diagram for describing an area ratio of the plurality of recesses according to the embodiment.

FIG. 7 is a diagram for describing a relationship between a piston speed and friction between the piston and the inner wall surface in two comparative examples of a case where first recesses are formed in an entire application region in the inner wall surface of the cylinder and a case where second recesses of one type are formed in the entire application region.

FIG. 8 is a diagram for describing a relationship between a piston speed and friction when the first recesses are formed in a first region in the inner wall surface of the cylinder according to the embodiment and second recesses of one type are formed in a second region and a third region in the inner wall surface of the cylinder according to the embodiment.

### DETAILED DESCRIPTION

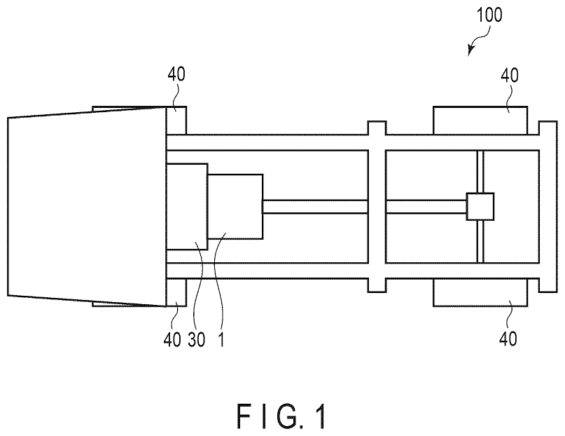

FIG. 1 is a schematic diagram illustrating an example of a structure of a vehicle 100 according to an embodiment. As illustrated in FIG. 1, the vehicle 100 includes an internal combustion engine 1, a transmission 30, and at least one wheel 40. In the vehicle 100, once the internal combustion engine 1 is driven, a driving force is transmitted to the at least one wheel 40 via the transmission 30.

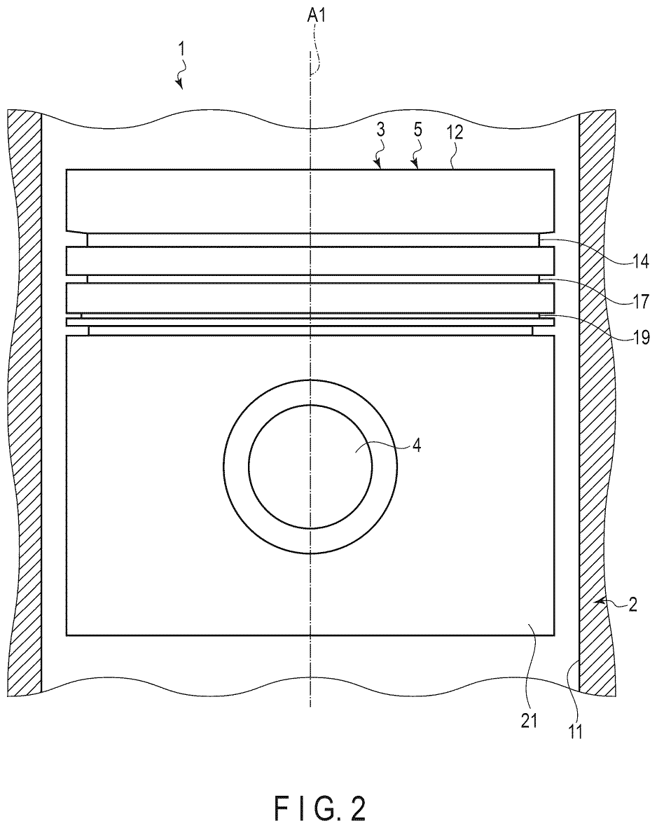

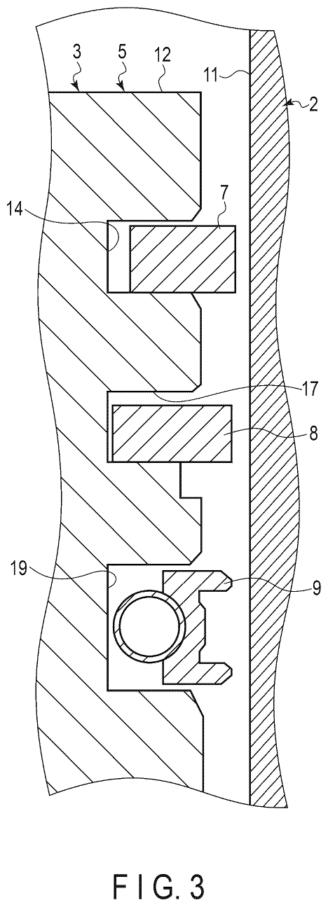

FIG. 2 is a schematic diagram illustrating an example of a structure of the internal combustion engine 1 according to the embodiment. FIG. 3 is a cross-sectional view schematically illustrating, by a cross section, an example of a structure of an outer peripheral surface and the vicinity thereof of a piston 3 according to the embodiment. As illustrated in FIG. 2 and FIG. 3, the internal combustion engine 1 includes a suction valve (not illustrated), a cylinder 2, the piston 3, a piston pin 4, a crank arm (not illustrated), and a crank shaft (not illustrated). The piston 3 includes a piston body 5 and a plurality of piston rings. The internal combustion engine 1 according to embodiment is, for example, a 4-stroke engine that constitutes one cycle including four steps of suction, compression, expansion and exhaust. The internal combustion engine 1 according to the embodiment is, for example, a diesel engine. In this case, the piston rings according to the embodiment include, for example, a top ring 7, a second ring 8, and an oil ring 9. Hereinafter, a portion of the piston 3 between an edge of the top ring 7 on the suction valve side and an edge of the oil ring 9 on the crank shaft side is referred to as a region S.

The cylinder 2 extends along a center axis A1 and is formed in a tubular shape such as a cylindrical shape. The cylinder 2 has an inner wall surface 11. In the cylinder 2, an inside space covered by the inner wall surface 11 is formed. Hereinafter, a direction around the center axis A1 of the cylinder 2 is defined as a circumferential direction.

The piston 3 is disposed in the above-described inside space, and is coupled to the crank arm via the piston pin 4 or the like, which extends in a direction perpendicular to or substantially perpendicular to the center axis A1 of the cylinder 2. The crank arm is rotatably provided on the crank shaft. The piston 3 reciprocates along the center axis A1 of the cylinder 2 in the inside space in parallel with the rotation of the crank arm about the crank shaft. The axial direction of the cylinder 2 runs along a moving direction of the piston 3.

In the suction step of the internal combustion engine 1, the piston 3 descends toward the crank shaft side with respect to the suction valve, and reaches a bottom dead center. In the compression step, the piston 3 ascends toward the suction valve side from the bottom dead center, and reaches a top dead center. In the expansion step, the piston 3 descends to the bottom dead center once again. Then, in the exhaust step, the piston 3 ascends once again from the bottom dead center toward the suction valve side. In this manner, the piston 3 reciprocates between the top dead center and the bottom dead center.

Specifically, the piston 3 is stationary with respect to the inner wall surface 11 at the top dead center, and moves from the top dead center toward the bottom dead center while accelerating. The piston 3 transitions from acceleration to deceleration between the top dead center and the bottom dead center, and is stationary with respect to the inner wall surface 11 at the bottom dead center. Then, the piston 3 moves from the bottom dead center toward the top dead center while accelerating, transitions to deceleration between the top dead center and the bottom dead center, and is stationary with respect to the inner wall surface 11 at the top dead center.

In the piston 3, for example, a piston top surface 12, a top ring groove 14, a second ring groove 17, an oil ring groove 19, and a piston skirt 21 are formed in that order from the suction valve side. The piston top surface 12 is an end surface on the suction valve side in the piston 3, and faces toward the suction valve side. The piston skirt 21 forms an end surface on the crank shaft side in the piston 3, and the end surface on the crank shaft side that the piston skirt 21 forms faces toward crank shaft side.

The top ring 7 is disposed in the top ring groove 14. The second ring 8 is disposed in the second ring groove 17. The oil ring 9 is disposed in the oil ring groove 19.

In the present embodiment, the piston 3 used in the diesel engine, among internal combustion engines 1, is described as an example, but the embodiment is not limited to this. The piston 3 may be used in other internal combustion engines 1 such as a gasoline engine, aside from the case where the piston 3 is used in the diesel engine.

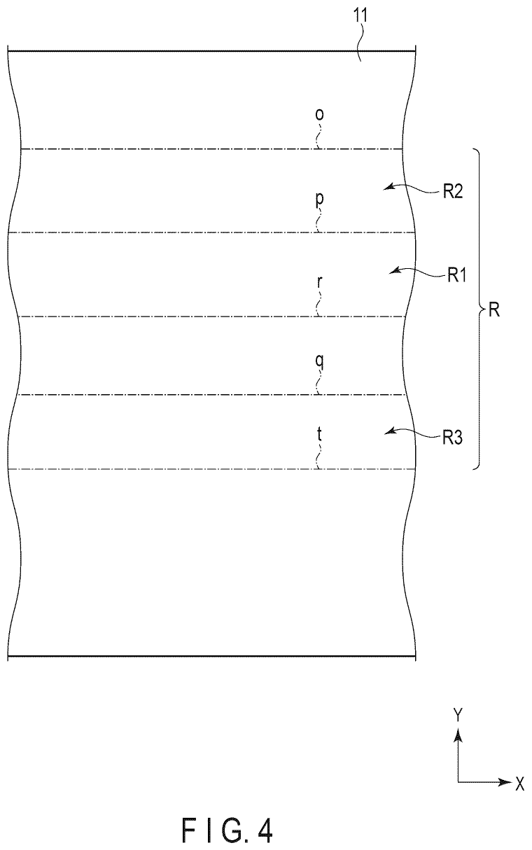

FIG. 4 is a schematic diagram illustrating a structure of the inner wall surface 11 of the cylinder 2 according to the embodiment. The inner wall surface 11 runs along the axial direction and the circumferential direction of the cylinder 2. FIG. 4 illustrates a state in which the cylinder 2 is developed and a part of the inner wall surface 11 is viewed from the inside space side covered by the inner wall surface 11 of the cylinder 2. A direction along the circumferential direction of the cylinder 2 is defined as an X-axis direction, and an axial direction along the center axis A1 of the cylinder 2 is defined as a Y-axis direction. In the Y-axis direction, the suction valve side is defined as a positive direction of the Y-axis direction and is referred to as an upper side. In addition, in the Y-axis direction, the crank shaft side is defined as a negative direction of the Y-axis direction and is referred to as a lower side. In the inner wall surface 11, a portion o facing the oil ring 9 when the piston 3 is located at the top dead center is located on the upper side with respect to a portion t facing the top ring 7 when the piston 3 is located at the bottom dead center.

In the inner wall surface 11 according to the embodiment, a plurality of recesses are formed in a predetermined application region R illustrated in FIG. 4. Note that the phrase “forming a plurality of recesses in the inner wall surface 11” may be rephrased as “applying texturing to the inner wall surface 11.” In the embodiment, a top end of the application region R to which texturing is applied is located at the same position as the portion o of the inner wall surface 11 that faces the oil ring 9 when the piston 3 is located at the top dead center. In addition, the bottom end of the application region R is located at the same position as the portion t of the inner wall surface 11 that faces the top ring 7 when the piston 3 is located at the bottom dead center. The embodiment is not limited thereto. The top end of the application region R may be located at, for example, a position on the lower side with respect to the portion o and in the vicinity of the portion o, and the bottom end of the application region R may be located at, for example, a position on the upper side with respect to the portion t and in the vicinity of the portion t. In addition, the range may be narrower than the application region R in the inner wall surface 11 according to the embodiment. In addition, the embodiment is not limited to the structure in which the plurality of recesses are formed over the entire circumference of the inner wall surface 11 in the application region R. In one example, the plurality of recesses do not need to be formed over the entire circumference of the inner wall surface 11 in the application region R.

The application region R according to the embodiment is, as illustrated in FIG. 4, divided into, for example, three regions of a first region R1, a second region R2, and a third region R3. In FIG. 4, a virtual boundary p is defined between the portion o and the portion t. In addition, a virtual boundary q is defined between the boundary p and the portion t. The first region R1 corresponds to a region between the boundary p and the boundary q. The second region R2 corresponds to a region between the portion o and the boundary p. The third region R3 corresponds to a region between the boundary q and the portion t. The first region R1 is on the lower side with respect to the second region R2 and on the upper side with respect to the third region R3. The first region R1 and the second region R2 are continuous in the moving direction of the piston 3. In addition, the first region R1 and the third region R3 are continuous in the moving direction of the piston 3. The first region R1 and the second region R2 do not necessarily have to be continuous in the moving direction of the piston 3. In this case, recesses do not need to be formed in a region between the top end of the first region R1 and the bottom end of the second region R2. In addition, the first region R1 and the third region R3 do not necessarily have to be continuous in the moving direction of the piston 3. In this case, recesses do not need to be formed in a region between the bottom end of the first region R1 and the top end of the second region R2.

When at least a part of the region S of the piston 3 faces the first region R1, the piston 3 moves at a higher speed than when the entire region S faces the second region R2 and when the entire region S faces the third region R3. Thus, the first region R1 is also referred to as a high-speed region. In addition, the first region R1 is also referred to as a bore midsection. On the other hand, the second region R2 or the third region R3 is referred as a low-speed region.

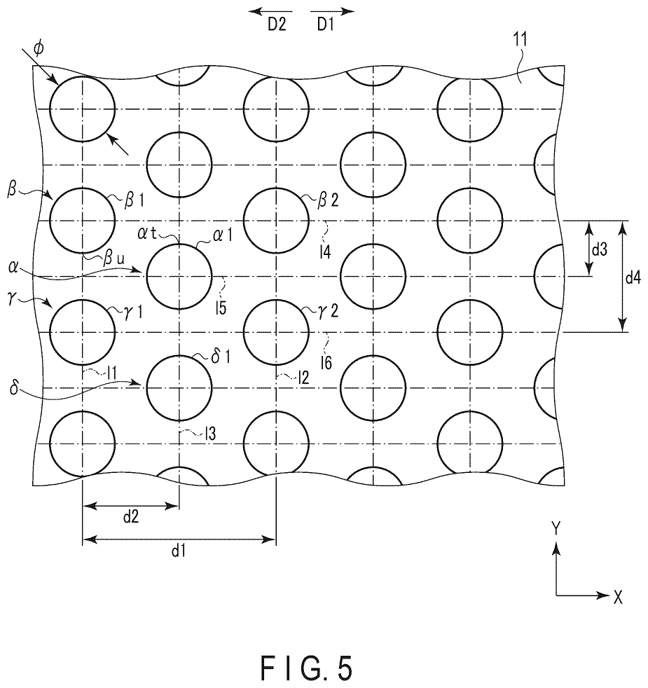

FIG. 5 is a diagram for describing a plurality of recesses according to the embodiment. FIG. 5 illustrates a state in which a part of the application region R is viewed from the inside space side covered by the inner wall surface 11. Each of the plurality of recesses has, for example, a dimple shape. The embodiment is not limited thereto, and each of the plurality of recesses may have another shape. As illustrated in FIG. 5, in each of the plurality of recesses formed in the inner wall surface 11 according to the embodiment, the opening has the same shape. The shape being the same includes, for example, that the shapes of the openings of the recesses are congruent, or that the difference in area of the recesses is small and the recesses are similar to each other. In each of the plurality of recesses, the shape of the opening is, for example, a circular shape, and the diameter φ of the opening is, for example, 0.25 mm. The shape of the opening may be another shape such as a rectangular shape or a diamond shape.

Here, the arrangement of each of the plurality of recesses formed in the inner wall surface 11 according to the embodiment will be described. In the application region R, a plurality of recess rows are formed. The plurality of recess rows are formed offset from each other in the moving direction of the piston 3 from the top end to the bottom end of the application region R. In other words, at least one of the plurality of recess rows is formed offset from other recess rows in the moving direction of the piston 3. As illustrated in FIG. 5, in one example, the plurality of recess rows are arranged at a constant pitch along the moving direction of the piston 3.

In each of the plurality of recess rows, two or more recesses of one type are arranged in the circumferential direction. Hereinafter, one of the plurality of recess rows is defined as a recess row α. The recess row α is not any one of the uppermost recess row, the lowermost recess row, or the recess row adjacent to the lowermost recess row on the upper side. A recess row adjacent to the recess row α on the upper side is defined as a recess row β. A recess row adjacent to the recess row α on the lower side is defined as a recess row γ. A recess row adjacent to the recess row γ on the lower side is defined as a recess row δ.

Two or more recesses of the recess rows adjacent to each other in the moving direction of the piston 3 are arranged in a staggered manner. Specifically, in the recess rows adjacent in the moving direction of the piston 3, two or more recesses of the upper-side recess row and two or more recesses of the lower-side recess row are alternately arranged along the circumferential direction. As illustrated in FIG. 5, each of the two or more recesses constituting the recess row α is positioned offset in the circumferential direction of the inner wall surface 11 with respect to each of the two or more recesses constituting the recess row β adjacent to the recess row α on the upper side. Furthermore, each of the two or more recesses constituting the recess row α is positioned offset in the circumferential direction of the inner wall surface 11 with respect to each of the two or more recesses constituting the recess row γ adjacent to the recess row α on the lower side. Each of the two or more recesses constituting the recess row β adjacent to the recess row α on the upper side is located at the same or substantially the same position in the circumferential direction as the corresponding one of the two or more recesses constituting the recess row γ adjacent to the recess row α on the lower side. That is, with respect to each of the two or more recesses constituting the recess row β, a corresponding recess of the two or more recesses constituting the recess row γ is located at the same or substantially the same position in the circumferential direction of the inner wall surface 11, in a one-to-one correspondence. Here, in FIG. 5, a straight line that passes through the center of a recess β1 which is one of the two or more recesses constituting the recess row β and extends along the moving direction of the piston 3 is defined as l1, and the straight line l1 passes through the center of a recess γ1 of the recess row γ. In addition, a recess that is adjacent to the recess β1 and is located offset toward one side in the circumferential direction with respect to the recess β1 is referred to as a recess β2. A straight line that passes through the center of the recess β2 and extends along the moving direction of the piston 3 is defined as l2. Hereinafter, the side on which the recess β2 is located with respect to the recess β1 is referred to as a first side D1. At this time, the straight line l2 passes through the center of the recess γ2 that is adjacent to the recess γ1 and offset from the recess γ1 toward the first side D1. In one example, a distance d1 between the straight line l1 and the straight line l2 along the circumferential direction of the inner wall surface 11 is 0.744 mm. In one example, in the recess row, two or more recesses adjacent to each other in the circumferential direction are arranged at a constant pitch along the circumferential direction.

Furthermore, each of the two or more recesses constituting the recess row α adjacent to the recess row γ on the upper side is located at the same or substantially the same position in the circumferential direction as the corresponding one of the two or more recesses constituting the recess row δ adjacent to the recess row γ on the lower side. That is, with respect to each of the two or more recesses constituting the recess row α, a corresponding recess of the two or more recesses constituting the recess row δ is located at the same or substantially the same position in the circumferential direction of the inner wall surface 11, in a one-to-one correspondence. In FIG. 5, of the two or more recesses constituting the recess row α, a recess located on the first side D1 with respect to the recess β1 and located on a second side D2 opposite to the first side D1 with respect to the recess β2 is defined as a recess α1. In addition, a straight line that passes through the center of the recess α1 and extends along the moving direction of the piston 3 is defined as l3, and the straight line l3 passes through the center of a recess δ1 which is one of the two or more recesses constituting the recess row δ. In one example, the recess α1 is located offset from the recess β1 toward the first side D1 by a half pitch and also offset from the recess β2 toward the second side D2 by a half pitch. Therefore, in one example, a distance d2 between the straight line l1 and the straight line l3 along the circumferential direction is 0.372 mm, which is half the distance d1. As described above, in the application region R, the recess rows such as the recess row β and the recess row γ including the recesses passing through the straight line l1 and the recess rows such as the recess row α and the recess row δ including the recesses passing through the straight line l3 are alternately arranged.

In addition, in the recess rows adjacent to each other in the moving direction of the piston 3, the bottom end of the upper-side recess row is located below the top end of the lower-side recess row. In other words, in the recess rows adjacent to each other in the moving direction of the piston 3, the bottom end of each of the two or more recesses constituting the upper-side recess row is located below the top end of each of the two or more recesses constituting the lower-side recess row. A phrase such as “the bottom end of the upper-side recess row being located below the top end of the lower-side recess row” may be rephrased as a phrase such as “overlapping each other in the axial direction.” Specifically, as shown in FIG. 5, in the recess rows adjacent to each other in the moving direction of the piston 3, a bottom end βu of the recess β1 constituting the upper-side recess row β is located below a top end αt of the recess α1 constituting the lower-side recess row α.

In FIG. 5, a straight line that passes through the center of the recess β1 and extends along the circumferential direction of the inner wall surface 11 is defined as l4, and a straight line that passes through the center of the recess α1 and extends along the circumferential direction of the inner wall surface 11 is defined as l5. In addition, a straight line that passes through the center of the recess γ1 and extends along the circumferential direction of the inner wall surface 11 is defined as l6. At this time, a distance d3 between the straight line l4 and the straight line l5 along the moving direction of the piston 3 is half a distance d4 between the straight line l4 and the straight line l6 along the moving direction of the piston 3. The distance d3 is, for example, 0.215 mm, and the distance d4 is, for example, 0.430 mm.

In the recess rows adjacent to each other in the moving direction of the piston 3, the bottom end of the upper-side recess row is located below the top end of the lower-side recess row, and the boundary p and the boundary q are not straight lines but curved lines.

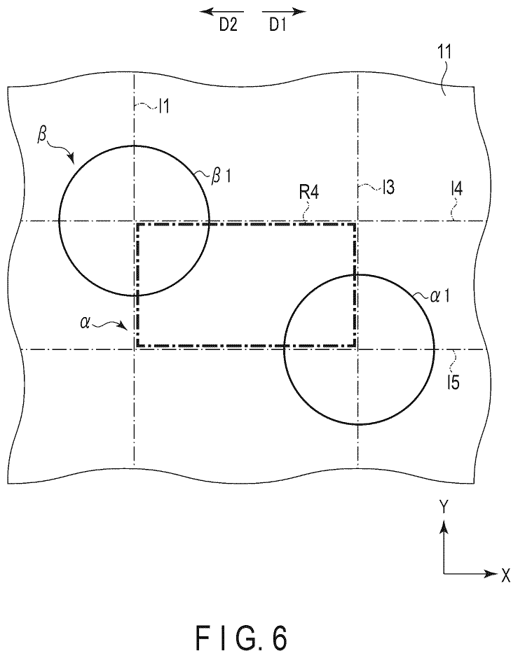

Next, an area ratio of the plurality of recesses will be described. The area ratio is a value indicating a ratio of a total opening area of the plurality of recesses to the entire application region R. FIG. 6 is a diagram for describing an area ratio of the plurality of recesses according to the embodiment. Specifically, FIG. 6 illustrates, as one example, the recess β1 and the recess α1 which are parts of the plurality of recesses illustrated in FIG. 5 and the vicinity of these recesses in an enlarged manner. In FIG. 6, a rectangular region R4 is defined. The region R4 is a region surrounded by the four straight lines l1, l3, l4, and l5. The area ratio of the plurality of recesses is defined by the ratio of the area occupied by the openings of the recesses in the region R4 to the area of the region R4. In one example, the area ratio is 20% or more and 50% or less.

In the inner wall surface 11, a plurality of types of recesses are formed offset for each type in the moving direction of the piston 3. For the plurality of types of recesses, the influence on the relationship between the moving speed of the piston 3 and the friction between the inner wall surface 11 and the piston 3 is different for each type. In the inner wall surface 11 according to the embodiment, for example, recesses of two types are formed. Hereinafter, a recess of a type that provides the maximum reduction in friction when the piston 3 moves at a first speed is referred to as a first recess. A recess of a type that reduces friction more than the first recess when the piston 3 moves at a second speed slower than the first speed is referred to as a second recess. The second recesses of only one type may be provided or the second recesses of a plurality of types may be provided. The first speed is higher than the reference value, and the second speed is equal to or lower than the reference value. That is, the first recess is the type that provides the maximum reduction in friction under higher-speed movement of the piston 3 than the reference value. The second recess is the type that reduces friction more than the first recess under lower-speed movement of the piston 3 than the reference value. The reference value is determined based on the relationship between the friction between the piston 3 and the inner wall surface 11 in which the first recesses are formed and the speed of the piston 3, and the relationship between the friction between the piston 3 and the inner wall surface 11 in which the second recesses are formed and the speed of the piston 3.

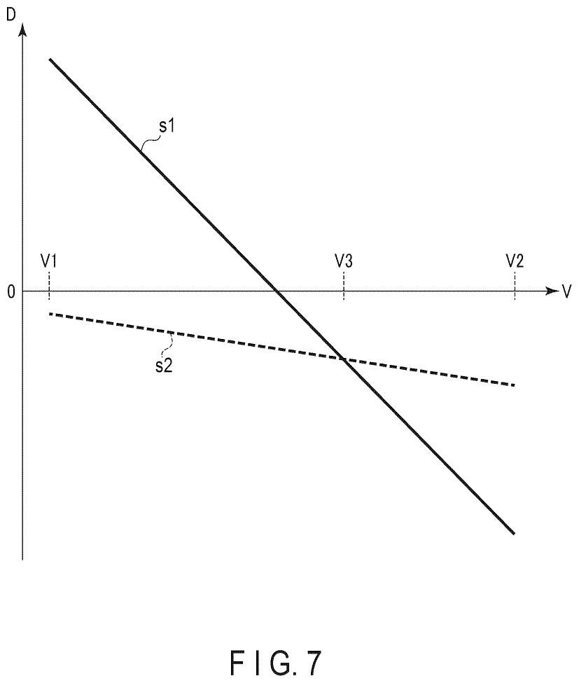

FIG. 7 is a diagram for describing the relationship between the speed of the piston 3 and the friction between the piston 3 and the inner wall surface 11 in two comparative examples of a case where the first recesses are formed in the entire application region R and a case where second recesses of one type are formed in the entire application region R in the inner wall surface 11. In FIG. 7, the horizontal axis represents the speed of the piston 3 with respect to the inner wall surface 11, and the vertical axis represents the change amount D of the friction obtained by subtracting the friction when the recesses are not formed in the inner wall surface 11 from the friction when the recesses are formed in the inner wall surface 11. That is, when the change amount D is positive, as a result of formation of the recesses in the inner wall surface 11, the friction is increased as compared with the state in which the recesses are not formed in the inner wall surface 11. On the other hand, when the change amount D is negative, as a result of formation of the recesses in the inner wall surface 11, the friction is reduced as compared with the state in which the recesses are not formed in the inner wall surface 11. In FIG. 7, V1 represents the speed of the piston 3 when the oil ring 9 passes through the top end of the application region R. The speed of the piston 3 when the top ring 7 passes through the bottom end of the application region R is equal to or substantially equal to V1. In FIG. 7, V2 represents the maximum speed of the piston 3 when the piston 3 transitions from acceleration to deceleration. Here, a portion of the inner wall surface 11 that the second ring 8 faces when the speed of the piston 3 is V2 is defined as a specified position r. The first region R1 is defined as a region including at least the specified position r. In one example, a distance from the portion o to the specified position r along the moving direction of the piston 3 coincides or substantially coincides with a distance from the portion t to the specified position r along the moving direction of the piston 3.

In FIG. 7, a line segment s1 indicated by a solid line represents the change amount D with respect to the speed of the piston 3 in the first comparative example in which the first recesses are formed in the entire application region R. On the other hand, a line segment s2 indicated by a broken line represents the change amount D with respect to the speed of the piston 3 in the second comparative example in which the second recesses of one type are formed in the entire application region R. As illustrated in FIG. 7, the line segment s1 intersects the line segment s2. In FIG. 7, the speed of the piston 3 when the line segment s1 intersects the line segment s2 is defined as V3. V3 is an example of the reference value.

In the following description of the embodiment, of the two portions facing the oil ring 9 when the speed of the piston 3 is V3, the portion located above the specified position r will be described as the boundary p between the first region R1 and the second region R2. In addition, of the two portions facing the top ring 7 when the speed of the piston 3 is V3, the portion located below the specified position r will be described as the boundary q between the first region R1 and the third region R3. When the speed of the piston 3 is V1 or higher and less than V3, the entire region S of the piston 3 faces the second region R2 or the third region R3. When the speed of the piston 3 is V3 or higher and V2 or lower, at least a part of the region S of the piston 3 faces the first region R1.

In the inner wall surface 11 according to the embodiment, the first recesses are formed in the first region R1. Therefore, when the speed of the piston 3 is higher than V3 and V2 or lower, at least a part of the region S of the piston 3 faces and slides against the first region R1 in which the first recesses are formed. The first speed is, for example, higher than V3 and V2 or lower.

In the embodiment, second recesses of one type are formed in the second region R2 and the third region R3. Therefore, when the speed of the piston 3 is V1 or higher and V3 or lower, the entire region S of the piston 3 faces and slides against the second region R2 or the third region R3 in which the second recesses are formed. The second speed is, for example, V1 or higher and V3 or lower. The second recesses are formed at a portion where the amount of offset from the specified position r is larger than that at the portion where the first recesses are formed. In another example, the boundary p may be a portion located above the specified position r of the two portions facing the piston rings other than the oil ring 9 when the speed of the piston 3 is V3. Furthermore, in another example, the boundary q may be a portion located below the specified position r of the two portions facing the piston rings other than the top ring 7 when the speed of the piston 3 is V3.

As shown in FIG. 7, when the speed of the piston 3 is V1 or higher and less than V3, the change amount D in the state in which the second recesses are formed is smaller than the change amount D in the state in which the first recesses are formed in the inner wall surface 11. Therefore, as compared to the first recesses, the second recesses have a higher friction-reducing effect when the piston 3 moves at the second speed, which is advantageous in the low-speed region. On the other hand, when the speed of the piston 3 is V3 or higher and V2 or lower, the change amount D in the state in which the first recesses are formed is smaller than the change amount D in the state in which the second recesses are formed in the inner wall surface 11. Therefore, as compared to the second recesses, the first recesses have a higher friction-reducing effect when the piston 3 moves at the first speed, which is advantageous in the high-speed region.

The depth of the first recess is formed to be greater than the depth of the second recess. The depth of the first recess is, for example, 3.0 μm or more and 5.0 μm or less. The depth of the second recess is, for example, 1.0 μm or more and 2.0 μm or less.

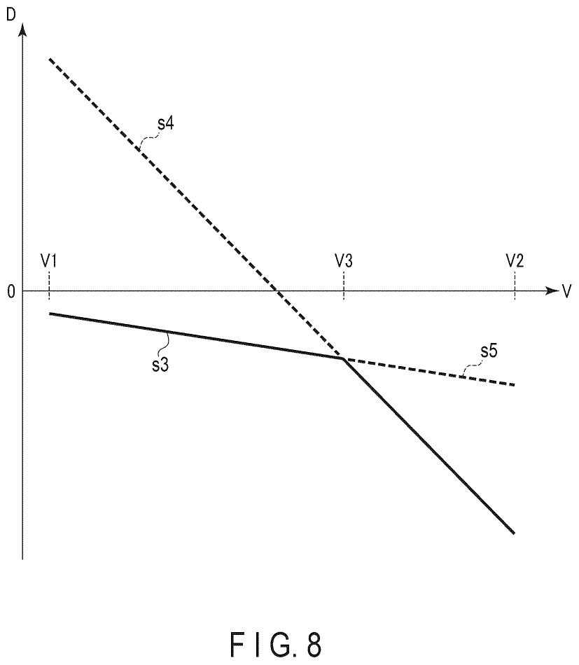

FIG. 8 is a diagram for describing a relationship between the speed of the piston 3 and the friction when the first recesses are formed in the first region R1 and the second recesses of one type are formed in the second region R2 and the third region R3 in the inner wall surface 11 according to the embodiment. In FIG. 8, the horizontal axis and the vertical axis are the same as those in FIG. 7. In FIG. 8, a polygonal line s3 indicated by a solid line represents the change amount D with respect to the speed of the piston 3 sliding against the inner wall surface 11 according to the embodiment. On the other hand, in FIG. 8, a line segment s4 indicated by a broken line represents the change amount D with respect to the speed of the piston 3 sliding against the inner wall surface 11 in which the first recesses are formed in the second region R2 and the third region R3. In addition, a line segment s5 indicated by a broken line represents the change amount D with respect to the speed of the piston 3 sliding against the inner wall surface 11 in which the second recesses are formed in the first region R1.

When the speed of the piston 3 is V1 or higher and less than V3, the piston 3 slides against the second region R2 or the third region R3 in which the second recesses providing a high friction-reducing effect under low-speed movement of the piston 3 are formed. For this reason, as shown by the polygonal line s3 and the line segment s4 in FIG. 8, it is possible to reduce the friction as compared with the case where the first recesses are formed in the second region R2 and the third region R3. On the other hand, when the speed of the piston 3 is V3 or higher and V2 or lower, the piston 3 slides against the first region R1 in which the first recesses providing a high friction-reducing effect under high-speed movement of the piston 3 are formed. Therefore, as shown by the polygonal line s3 and the line segment s5, it is possible to reduce the friction as compared with the case where the second recesses are formed in the first region R1. As described above, according to the above-described embodiment, as compared with the first comparative example and the second comparative example, it is possible to reduce friction in the low-speed region while achieving a large amount of friction reduction in the high-speed region. Since the friction between the piston ring and the inner wall surface 11 is reduced and the friction between the piston body 5 and the inner wall surface 11 is also reduced, the friction between the piston 3 and the inner wall surface 11 is also reduced.

The structure in which in the inner wall surface 11 according to the embodiment, the first recesses are formed in the first region R1 and the second recesses are formed in the second region R2 and the third region R3 has been described as an example, but the embodiment is not limited thereto. For example, it is also possible to adopt a structure in which the second recesses are not formed in the third region R3 and the second recesses are formed only in the second region R2. In addition, it is also possible to adopt a structure in which the second recesses are not formed in the second region R2 and the second recesses are formed only in the third region R3.

The structure in which in the inner wall surface 11 according to the embodiment, the second recesses of only one type are formed in the second region R2 and the third region R3 has been described as an example, but the embodiment is not limited thereto. The second recesses of a plurality of types may be formed in at least one region of the second region R2 or the third region R3. Specifically, in a case where second recesses of a plurality of types are formed in the second region R2 which is a region between the top end of the first region R1 and the portion o, in the second region R2, recesses of a type that reduce friction during movement of the piston 3 at the second speed are formed at positions farther from the first region R1. In addition, in a case where second recesses of a plurality of types are formed in the third region R3 which is a region between the portion t and the bottom end of the first region R1, in the third region R3, recesses of a type that reduce friction during movement of the piston 3 at the second speed are formed at positions farther from the first region R1. The positions of the boundary p and the boundary q vary depending on the combination of the types of recesses formed in the inner wall surface 11.

In addition, recesses of a type providing the maximum reduction in friction during movement of the piston at the first speed have a depth greater than that of recesses of a type reducing friction during movement of the piston at the first speed.

According to the above-described embodiment, the cylinder 2 includes the inner wall surface 11 in which the plurality of types of recesses are formed offset for each type in the moving direction of the piston 3. For the plurality of types of recesses, the influence on the relationship between the moving speed of the piston 3 and the friction between the inner wall surface 11 and the piston 3 is different for each type. That is, in the high-speed region of the inner wall surface 11, recesses of a type providing high friction-reducing effects under high-speed movement of the piston 3 are formed, and in the low-speed region of the inner wall surface 11, recesses of a type providing high friction-reducing effects under low-speed movement of the piston 3 are formed. Thus, it is possible to reduce friction in the low-speed region while achieving a large friction reduction amount in the high-speed region.

Furthermore, according to the embodiment described above, in the first region R1, of the plurality of types of recesses, the first recesses that provide the maximum reduction in friction under high-speed movement of the piston 3 are formed. As compared with the first recesses, the second recesses of one or more types formed in a region of the inner wall surface 11 other than the first region reduce friction under low-speed movement of the piston 3. Thus, it is possible to further reduce friction in a low-speed region while further increasing the friction reduction amount in a high-speed region. In addition, in a case where a plurality of types of second recesses are provided, of the plurality of types of second recesses, recesses of a type formed at a position farther from the first region R1 reduce friction more under lower-speed movement of the piston. Thus, it is possible to further reduce friction in a low-speed region while further increasing the friction reduction amount in a high-speed region.

Furthermore, according to the embodiment, in addition to the advantageous effects described above, there can be provided the internal combustion engine 1 including the cylinder 2 that includes the inner wall surface 11 that reduces friction in the low-speed region while increasing the friction reduction amount in the high-speed region. In addition, the vehicle 100 including the internal combustion engine 1 can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A cylinder comprising:
an inner wall surface in which a plurality of types of recesses are formed in positions offset for each type in a moving direction of a piston,
for the plurality of types of recesses, an influence on a relationship between a moving speed of the piston and friction between the inner wall surface and the piston being different for each type,
in the inner wall surface, at least one of a plurality of recess rows being formed by the plurality of types of recesses in a position offset in the moving direction with respect to the other recess rows,
in each of the plurality of recess rows, two or more recesses of one type being arranged in a circumferential direction, and
in recess rows adjacent to each other in the moving direction, two or more recesses of an upper-side recess row and two or more recesses of a lower-side recess row being alternately arranged along the circumferential direction, and a bottom end of the upper-side recess row being located below a top end of the lower-side recess row.

2. The cylinder according to claim 1, wherein in a first region of the inner wall surface, of the plurality of types of recesses, first recesses of a type providing a maximum reduction in friction between the inner wall surface and the piston during movement of the piston at a first speed are formed, and in a region other than the first region of the inner wall surface, second recesses of one or more types reducing the friction more than the first recesses during movement of the piston at a second speed lower than the first speed are formed.

3. The cylinder according to claim 2, wherein
in the region other than the first region of the inner wall surface, a plurality types of second recesses are formed as the second recesses of one or more types, and
of the plurality of types of second recesses, second recesses of a type reducing the friction more during movement of the piston at the second speed are formed at positions farther from the first region.

4. The cylinder according to claim 2, wherein the first recesses have a depth greater than a depth of the second recesses of one or more types.

5. The cylinder according to claim 1, wherein openings of the plurality of types of recesses have a same shape.

6. The cylinder according to claim 5, wherein the shape of the openings of the plurality of types of recesses is circular.

7. The cylinder according to claim 1, wherein an area ratio of the plurality of types of recesses is 20% or more and 50% or less.

8. An internal combustion engine comprising:
the cylinder according to claim 1; and
the piston disposed in an inside space covered by the inner wall surface.

9. A vehicle comprising the internal combustion engine according to claim 8.
